(19) United States
(12) Patent Application Publication
(10) Pub. No.: US 2025/0263080 A1
(43) Pub. Date: Aug. 21, 2025

(54) DRIVER STATE ESTIMATION APPARATUS

(71) Applicant: Mazda Motor Corporation, Hiroshima (JP)

(72) Inventors: Daiki IZUMOTO, Aki-gun (JP); Koji IWASE, Aki-gun (JP)

(73) Assignee: Mazda Motor Corporation, Hiroshima (JP)

(21) Appl. No.: 19/039,790

(22) Filed: Jan. 29, 2025

(30) Foreign Application Priority Data
Feb. 15, 2024 (JP) 2024-021280

(51) Int. Cl. B60W 40/08; B60W 50/14; G06V 20/59

(52) U.S. Cl. CPC B60W 40/08; B60W 50/14; G06V 20/597; B60W 2050/143; B60W 2050/146; B60W 2420/403; B60W 2540/225; B60W 2554/4029; B60W 2555/60

(57) ABSTRACT

A driver state estimation apparatus includes an in-vehicle camera that detects the driver's line of sight; and a controller configured to estimate the driver's state based on the driver's line of sight. The controller sets a predetermined visual range including a line-of-sight direction in the case where the driver directs their line of sight in an advancing direction, acquires a distribution of the driver's gazing points within a predetermined time based on the driver's line of sight, and estimates that the driver is in an abnormal state in the case where a ratio of the gazing points included in the predetermined visual range among all the gazing points included in the acquired distribution of the gazing points is equal to or greater than a predetermined ratio.

### CROSS-REFERENCE TO RELATED APPLICATION

The present application claims priority from the Japanese patent application JP 2024-021280, filed on Feb. 15, 2024, the entire content of which is incorporated herein by reference in its entirety.

### TECHNICAL FIELD

The present disclosure relates to a driver state estimation apparatus that estimates a state of a driver who drives a vehicle.

### BACKGROUND

Conventionally, a driver state detection apparatus for detecting abnormality of a driver of a vehicle has been proposed (for example, see Patent Literature 1). The apparatus described in Patent Literature 1 detects an amplitude and a frequency of a saccade of the vehicle driver (a jumping eye movement of the driver to intentionally move a line of sight), also detects a degree of caution that is increased as the number of cautionary points to be checked by the driver during travel is increased in a vehicle external environment, and thereby detects the abnormality of the driver on the basis of the degree of caution and the amplitude and the frequency of the saccade of the driver.

### CITATION LIST

### Patent Literature

[Patent Literature 1] JP2021-077136A

### SUMMARY

### Technical Problems

In a travel environment that requires a quick visual search in a wide range, such as a situation where the driver attempts to make a right turn at an intersection and has to quickly move the line of sight in a wide range in order to simultaneously check a large number of cautionary objects such as a vehicle in an oncoming lane and a pedestrian who is about to walk on a crosswalk, the amplitude of the saccade is increased when the driver's state is normal, whereas the amplitude of the saccade is not increased and tends to remain at a low value when the driver's state is abnormal due to an outbreak of a brain disorder or the like. Thus, it is possible to estimate whether the driver's state is normal on the basis of the amplitude of the saccade.

However, in a travel environment that does not require the quick visual search in the wide range, such as a situation where there are a few other vehicles in the vicinity during travel on an expressway and the number of the cautionary objects is small, the amplitude of the saccade is not increased even when the driver's state is normal. Accordingly, a clear difference does not appear in the amplitude of the saccade between the case where the driver's state is normal and the case where the driver's state is abnormal. In this case, it is difficult to accurately estimate the driver's state by the conventional technique as described above. That is, it may be difficult to accurately estimate the driver's state depending on the travel environment.

The disclosure has been made to solve such problems and therefore describes providing a driver state estimation apparatus capable of accurately estimating a driver's state regardless of a travel environment.

### Solutions to Problems

In order to solve the above-described problems, the disclosure describes a driver state estimation apparatus that estimates a state of a driver who drives a vehicle, and includes: a line-of-sight detection device that detects the driver's line of sight; and a controller configured to estimate the driver's state on the basis of the driver's line of sight. The controller is configured to: set a predetermined visual range that includes a line-of-sight direction in the case where the driver directs his/her line of sight in an advancing direction of the vehicle; acquire a distribution of the driver's gazing points within predetermined time on the basis of the driver's line of sight; and estimate that the driver is in an abnormal state in the case where a ratio of the gazing points included in the predetermined visual range among all the gazing points included in the acquired distribution of the gazing points is equal to or greater than a predetermined ratio.

According to the disclosure configured as described above, the controller estimates that the driver is in the abnormal state when the ratio of the gazing points that are included in the predetermined visual range including the line-of-sight direction of the case where the driver directs his/her line of sight in the advancing direction of the vehicle among all the gazing points included in the distribution of the driver's gazing points within the predetermined time is equal to or greater than the predetermined threshold. Thus, based on the ratio of the gazing points included in the predetermined visual range, it is possible to identify that a tendency of the driver's line of sight to concentrate on the vicinity of the advancing direction due to some disorder is increased, and it is thus possible to accurately estimate that the driver is in the abnormal state regardless of the travel environment.

In the disclosure, preferably, the driver state estimation apparatus further includes a travel environment information acquisition device that acquires travel environment information of the vehicle, and the controller is configured to set a size of the predetermined visual range on the basis of the travel environment information.

According to the disclosure configured as described above, since the controller sets the size of the predetermined visual range on the basis of the travel environment information, by setting the predetermined visual range to the appropriate size according to the travel environment information, it is possible to further accurately estimate whether the driver's state is abnormal according to the travel environment.

In the disclosure, preferably, the controller is configured to: acquire the number of cautionary objects in the vicinity of the vehicle on the basis of the travel environment information; and set the predetermined visual range to be larger than that in the case where the number of the cautionary objects is less than a predetermined threshold when the number of the cautionary objects is equal to or greater than the predetermined threshold.

According to the disclosure configured as described above, when the number of the cautionary objects is equal to or greater than the predetermined threshold, the controller sets the predetermined visual range to be larger than that in the case where the number of the cautionary objects is less than the predetermined threshold. Accordingly, based on the characteristic that the tendency of the line of sight of the driver in the abnormal state to concentrate on the vicinity of the advancing direction of the vehicle is increased as the number of the cautionary objects is relatively small, it is possible to set the predetermined visual range in such a size that the difference from the driver in a normal state becomes apparent, and it is thus possible to further accurately estimate whether the driver's state is abnormal according to the travel environment.

In the disclosure, preferably, the controller is configured to set, as the predetermined visual range, a circular range centered on an average direction of the distribution of the line-of-sight directions within a predetermined time, on the basis of the driver's line of sight.

According to the disclosure configured as described above, since the controller sets the circular range centered on the average direction of the distribution of the line-of-sight directions within the predetermined time as the predetermined visual range, it is possible to set the predetermined visual range serving as a reference for estimating the driver's state on the basis of the line-of-sight direction of the actual driver, and it is thus possible to further accurately estimate whether the driver's state is abnormal.

### Advantage Effects

According to the driver state estimation apparatus in the disclosure, it is possible to accurately estimate the driver's state regardless of the travel environment.

### BRIEF DESCRIPTION OF DRAWINGS

FIG. 1 is a view illustrating a vehicle on which a driver state estimation apparatus according to an exemplary embodiment.

FIG. 2 is a block diagram of the driver state estimation apparatus according to an exemplary embodiment.

FIG. 3 is a view exemplifying a distribution of gazing points of a driver who visually recognizes an advancing direction of the vehicle.

FIG. 4 is a graph illustrating a relationship between a size of a central range and a center checking ratio p.

FIG. 5 is a graph illustrating a difference Δp between a center checking ratio pᵤ of a subject with a brain disorder and a center checking ratio pₙ of a subject without a disorder.

FIG. 6 is a flowchart of driver state estimation processing according to an exemplary embodiment.

### DETAILED DESCRIPTION

Hereinafter, a driver state estimation apparatus according to an embodiment of the disclosure will be described with reference to the accompanying drawings.

### System Configuration

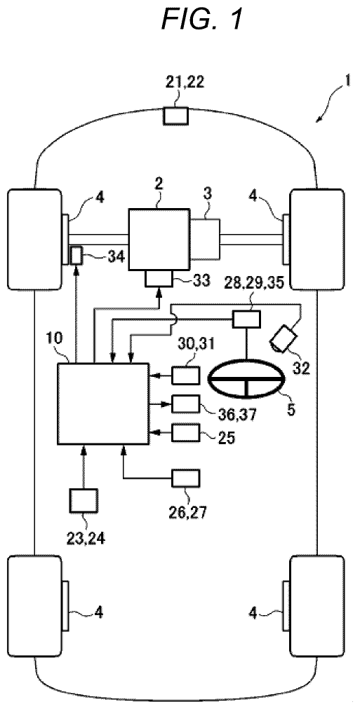

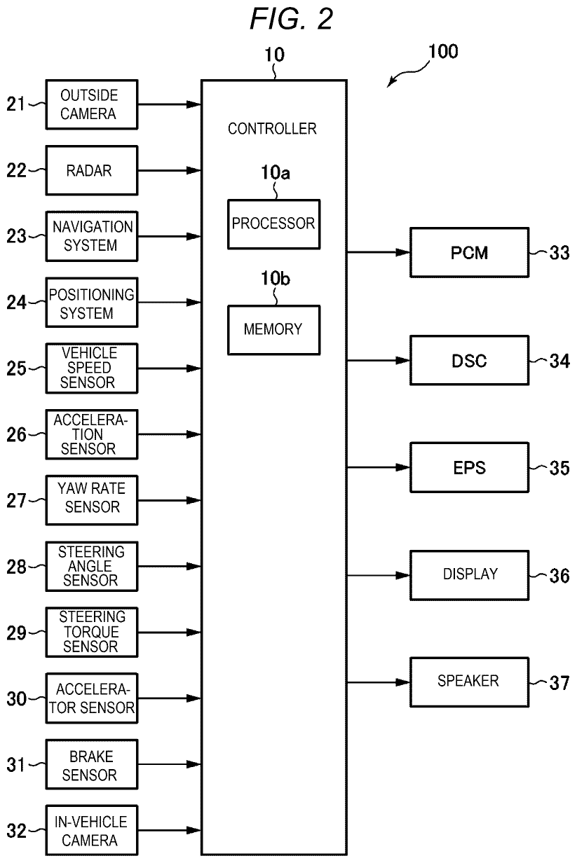

First, a configuration of the driver state estimation apparatus according to the present embodiment will be described with reference to FIGS. 1 and 2. FIG. 1 is a view illustrating a vehicle on which the driver state estimation apparatus is mounted, and FIG. 2 is a block diagram of the driver state estimation apparatus.

A vehicle 1 according to the present embodiment includes: a driving force source 2, such as an engine or an electric motor, that outputs a driving force; a transmission 3 that transmits the driving force output from the driving force source 2 to drive wheels; a brake 4 that applies a braking force to the vehicle 1; and a steering device 5 for steering the vehicle 1.

A driver state estimation apparatus 100 is configured to estimate a state of a driver of the vehicle 1 and execute control of the vehicle 1 and driver assistance control when necessary. As illustrated in FIG. 2, the driver state estimation apparatus 100 includes a controller 10, a plurality of sensors, a plurality of control systems, and a plurality of information output devices.

More specifically, the plurality of sensors includes an outside camera 21 and a radar 22 for acquiring travel environment information of the vehicle 1, and a navigation system 23 and a positioning system 24 for detecting a position of the vehicle 1. The plurality of sensors also includes a vehicle speed sensor 25, an acceleration sensor 26, a yaw rate sensor 27, a steering angle sensor 28, a steering torque sensor 29, an accelerator sensor 30, and a brake sensor 31 for detecting behavior of the vehicle 1 and a driving operation by the driver. The plurality of sensors further includes an in-vehicle camera 32 for detecting the driver's line of sight. The plurality of control systems includes a powertrain control module (PCM) 33 that controls the driving force source 2 and the transmission 3, a dynamic stability control system (DSC) 34 that controls the driving force source 2 and the brake 4, and an electric power steering system (EPS) 35 that controls the steering device 5. The plurality of information output devices includes a display 36 that outputs image information and a speaker 37 that outputs audio information.

Moreover, other sensors may include: a peripheral sonar that measures a distance to and a position of a structure around the vehicle 1; corner radars, each of which measures approach of the peripheral structure at respective one of four corners of the vehicle 1; and various sensors, each of which estimates the driver's state (for example, a heartbeat sensor, an electrocardiogram sensor, a steering wheel grip force sensor, and the like).

The controller 10 performs various calculations on the basis of signals received from the plurality of sensors, transmits, to the PCM33, the DSC34, the EPS35, control signals for appropriately actuating the driving force source 2, the transmission 3, the brake 4, and the steering device 5, and transmits control signals for causing the display 36 and the speaker 37 to output desired information. The controller 10 is configured by a computer that includes one or more processors 10a (typically, CPUs), a memory 10b (ROM, RAM, and the like) for storing various programs and data, an input/output device, and the like.

The outside camera 21 captures an image of the surroundings of the vehicle 1 and outputs image data. The controller 10 recognizes an object (for example, a preceding vehicle, a parked vehicle, a pedestrian, a travel road, division lines (a lane boundary line, a white line, and a yellow line), a traffic signal, a traffic sign, a stop line, an intersection, an obstacle, and the like) on the basis of the image data received from the outside camera 21. The outside camera 21 corresponds to an example of the “travel environment information acquisition device” in the disclosure.

The radar 22 measures a position and a speed of the object (in particular, the preceding vehicle, the parked vehicle, the pedestrian, a dropped object on the travel road, or the like). A millimeter wave radar can be used as the radar 22, for example. The radar 22 transmits a radio wave in an advancing direction of the vehicle 1, and receives a reflected wave that is generated when the transmitted wave is reflected by the object. Then, the radar 22 measures a distance (for example, an inter-vehicle distance) between the vehicle 1 and the object and a relative speed of the object to the vehicle 1 on the basis of the transmitted wave and the received wave. In the present embodiment, instead of the radar 22, a laser radar, an ultrasonic sensor, or the like may be used to measure the distance to and the relative speed of the object. Alternatively, a plurality of sensors may be used to form a position and speed measurement device. The radar 22 corresponds to an example of the “travel environment information acquisition device” in the disclosure.

The navigation system 23 stores map information therein, and can provide the map information to the controller 10. The controller 10 identifies a road, the intersection, the traffic signal, a building, and the like that exist around (in particular, in the advancing direction of) the vehicle 1 on the basis of the map information and current vehicle position information. The map information may be stored in the controller 10. The positioning system 24 is a GPS system and/or a gyroscopic system, and detects the position of the vehicle 1 (the current vehicle position information). The navigation system 23 and the positioning system 24 also correspond to examples of the “travel environment information acquisition device” in the disclosure.

The vehicle speed sensor 25 detects a speed of the vehicle 1 on the basis of a rotational speed of the wheel or a driveshaft, for example. The acceleration sensor 26 detects acceleration of the vehicle 1. This acceleration includes acceleration in a longitudinal direction of the vehicle 1 and acceleration in a lateral direction (that is, lateral acceleration) thereof. In the present specification, the acceleration includes not only a change rate of the speed in a speed increasing direction but also a change rate of the speed in a speed reducing direction (that is, deceleration).

The yaw rate sensor 27 detects a yaw rate of the vehicle 1. The steering angle sensor 28 detects a rotation angle (a steering angle) of a steering wheel of the steering device 5. The steering torque sensor 29 detects torque (steering torque) that is applied to a steering shaft via the steering wheel. The accelerator sensor 30 detects a depression amount of an accelerator pedal. The brake sensor 31 detects a depression amount of a brake pedal.

The in-vehicle camera 32 captures an image of the driver and outputs image data. The controller 10 detects the driver's line-of-sight direction on the basis of the image data received from the in-vehicle camera 32. The in-vehicle camera 32 corresponds to an example of the “line-of-sight detection device” in the disclosure.

The PCM 33 controls the driving force source 2 of the vehicle 1 to adjust the driving force of the vehicle 1. For example, the PCM 33 controls a spark plug, a fuel injection valve, a throttle valve, and a variable valve mechanism of the engine, the transmission 3, an inverter that supplies electric power to the electric motor, and the like. When the vehicle 1 has to be accelerated or decelerated, the controller 10 transmits a control signal for adjusting the driving force to the PCM 33.

The DSC 34 controls the driving force source 2 and the brake 4 of the vehicle 1 and executes deceleration control and posture control of the vehicle 1. For example, the DSC 34 controls a hydraulic pump, a valve unit, and the like of the brake 4, and controls the driving force source 2 via the PCM 33. When the deceleration control or the posture control of the vehicle 1 has to be executed, the controller 10 transmits, to the DSC 34, a control signal for adjusting the driving force or generating the braking force.

The EPS 35 controls the steering device 5 of the vehicle 1. For example, the EPS 35 controls an electric motor that applies the torque to the steering shaft of the steering device 5, and the like. When the advancing direction of the vehicle 1 has to be changed, the controller 10 transmits a control signal for changing a steering direction to the EPS 35.

The display 36 is provided in front of the driver in a cabin, and shows the image information for the driver. A liquid crystal display or a head-up display is used as the display 36, for example. The speaker 37 is installed in the cabin and outputs various types of the audio information.

### [Overview of Driver State Estimation]

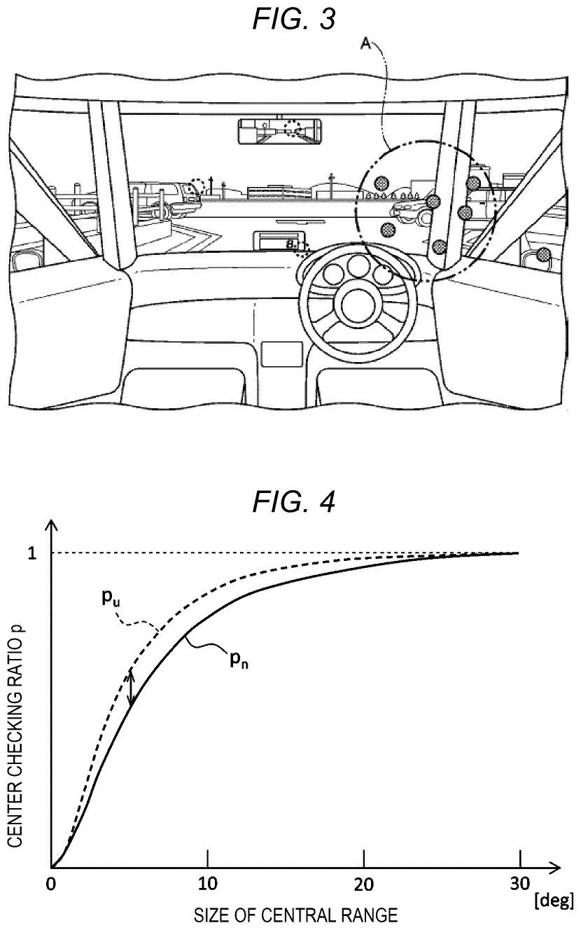

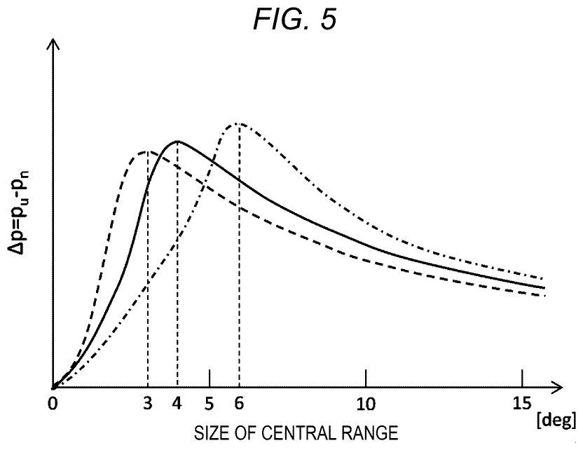

Next, an overview of driver state estimation by the driver state estimation apparatus 100 of the present embodiment will be described with reference to FIG. 3 to FIG. 5. FIG. 3 is a view exemplifying a distribution of gazing points of the driver who visually recognizes the advancing direction of the vehicle. FIG. 4 is a graph illustrating a relationship between a size of a central range and a center checking ratio p that represents a ratio of the gazing points included in the central range to all the gazing points. FIG. 5 is a graph illustrating a difference Δp between a center checking ratio pᵤ in an abnormal state and a center checking ratio pₙ in a normal state.

The present inventors conducted driving experiments on a plurality of subjects having a brain disorder and a plurality of healthy subjects having no disorder by using a driving simulator in order to examine how behavior of the driver to visually check the surroundings of the vehicle (in particular, in the advancing direction of the vehicle) (hereinafter, referred to as “search behavior”) is changed between a case where the driver's state was normal and a case where the driver's state was abnormal. More specifically, each of the drivers was made to travel in various travel environments (an ordinary road without an intersection, an ordinary road with an intersection, an expressway, and the like) where the number of the objects (cautionary objects) to which the driver should pay attention differed, and movement of the line of sight of each of the subjects during driving was measured.

As a result, it was found that the healthy subjects without the disorder (corresponding to the drivers in the normal state) repeatedly performed such search behavior that each of the subjects basically directed his/her line of sight to the vicinity of the advancing direction of the vehicle, temporarily moved his/her line of sight in a direction toward the cautionary object (for example, another vehicle, a rear-view mirror, a side mirror, or the like) separated from the advancing direction, and returned his/her line of sight to the vicinity of the advancing direction again, thereby checking the surroundings of the vehicle.

Meanwhile, in regard to the subjects having the brain disorder (corresponding to the drivers in the abnormal state), such a result was obtained that a large proportion of the subjects each directed his/her line of sight to the vicinity of the advancing direction of the vehicle and, compared to the subjects without the disorder, was less likely to move his/her line of sight in the direction away from the advancing direction.

Accordingly, in order to quantitatively evaluate the ratio of directing the line of sight to the vicinity of the advancing direction of the vehicle, the present inventors extracted the gazing points at which the line of sight stagnated for a predetermined time (for example, 0.3 second) for each of the subjects having the brain disorder and the subjects without the disorder, and acquired a distribution of the gazing points. Then, as exemplified in FIG. 3, the present inventors identified the number of the gazing points (points indicated by black circles in FIG. 3) that were included in a predetermined visual range (hereinafter, referred to as a “central range”, and a range of the circle A indicated by an imaginary line in FIG. 3) including the line-of-sight direction when the driver directed his/her line-of-sight in the advancing direction of the vehicle and the number of the gazing points outside the central range (points indicated by white circles in FIG. 3), and calculated the ratio of the gazing points included in the central range to all the gazing points (hereinafter, referred to as a “center checking ratio”).

FIG. 4 illustrates a relationship between the size of the central range and the center checking ratio p when the driving experiment was performed using the driving simulator on the ordinary road without the intersection. In FIG. 4, a horizontal axis represents the size of the central range (a value acquired by representing a radius of the central range by a viewing angle with a head position of the driver being a reference), and a vertical axis represents the center checking ratio p. In addition, a broken line in FIG. 4 indicates a center checking ratio pᵤ of the subjects having the brain disorder, and a solid line indicates the center checking ratio pₙ of the subjects without the disorder.

As illustrated in FIG. 4, regardless of the size of the central range, the center checking ratio pᵤ of the subjects having the brain disorder is greater than the center checking ratio pₙ of the subjects without the disorder. This indicates that a percentage of the subjects directing their line of sight to the vicinity of the advancing direction of the vehicle is higher in the subjects with the brain disorder than the subjects without the disorder. Furthermore, in a range of 2 deg to 15 deg in the size of the central range, a difference between the center checking ratio pᵤ of the subjects having the brain disorder and the center checking ratio pₙ of the subjects without the disorder is particularly large.

Here, FIG. 5 illustrates the difference Δp between the center checking ratio pᵤ of the subjects having the brain disorder and the center checking ratio pₙ of the subjects without the disorder. In FIG. 5, a horizontal axis represents the size of the central range, and a vertical axis represents Δp=pᵤ−pₙ. In addition, a solid line in FIG. 5 indicates Δp at the time when the driving experiment is performed on the ordinary road without the intersection (that is, a travel environment where the number of the cautionary objects is average), a one-dot chain line indicates Δp at the time when the driving experiment is performed on the ordinary road with the intersection (that is, a travel environment where the number of the cautionary objects is relatively large), and a broken line indicates Δp at the time when the driving experiment is performed on the expressway (that is, a travel environment where the number of the cautionary objects is relatively small).

As illustrated in FIG. 5, regardless of the travel environment, Δp has a peak value in a range where the size of the central range is 2 deg to 15 deg. That is, there is a general tendency that the center checking ratio pᵤ of the subject with the brain disorder is greater than the center checking ratio pₙ of the subject without the disorder. Furthermore, the size of the central range where Δp reaches the peak becomes the maximum (6 deg) in the case of the travel environment where the number of the cautionary objects is relatively large (the one-dot chain line in FIG. 5), becomes the minimum (3 deg) in the case of the travel environment where the number of the cautionary objects is relatively small (the broken line in FIG. 5), and has an intermediate value (4 deg) in the case of the travel environment where the number of the cautionary objects is average (the solid line in FIG. 5). This indicates that, since a tendency of the line of sight of the subject having the brain disorder to be concentrated on the vicinity of the advancing direction of the vehicle is stronger than the subject without the disorder as the number of the cautionary objects is reduced, the difference in the center checking ratio p becomes greater, that is, a difference in the distribution of the gazing points becomes apparent as the central range is reduced. For such a reason, it is possible to accurately estimate whether the driver's state is abnormal regardless of the travel environment by calculating the center checking ratio p from the distribution of the driver's gazing points, and it is possible to further accurately estimate whether the driver's state is abnormal according to the travel environment by setting the central range in the appropriate size according to the number of the cautionary objects.

### [Driver State Estimation Processing]

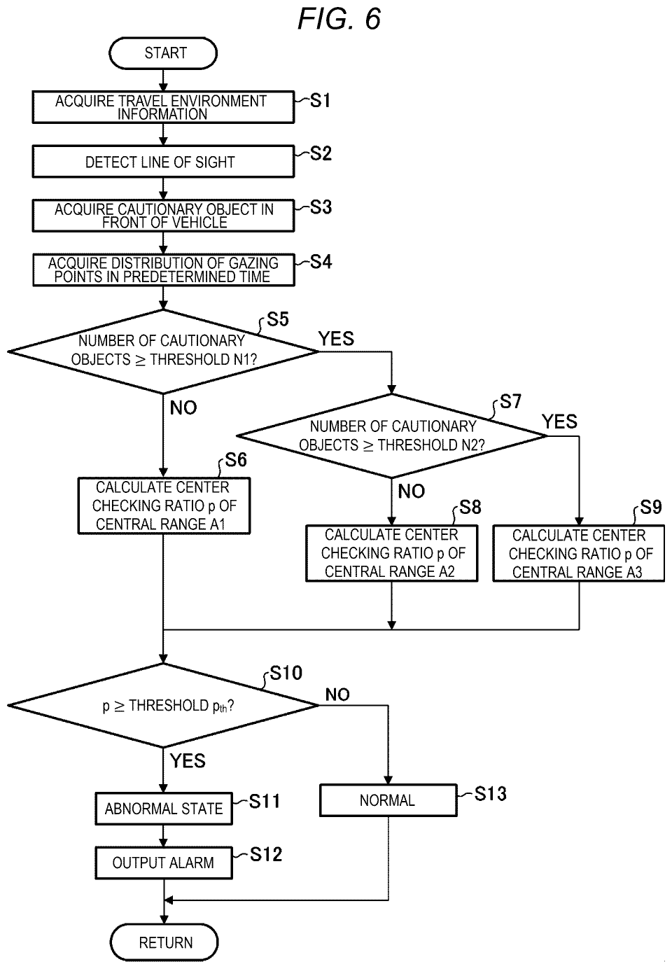

Next, a flow of driver state estimation processing executed by the driver r state estimation apparatus 100 according to the present embodiment will be described with reference to FIG. 6. FIG. 6 is a flowchart of the driver state estimation processing for estimating the driver's state.

The driver state estimation processing in FIG. 6 is started when the vehicle 1 is powered on, and is repeatedly executed by the controller 10 in a predetermined cycle (for example, every 0.05 to 0.2 second).

When the driver state estimation processing is started, the controller 10 acquires the travel environment information on the basis of the signals received from the sensors including the outside camera 21, the radar 22, the navigation system 23, the positioning system 24, the vehicle speed sensor 25, the acceleration sensor 26, the yaw rate sensor 27, the steering angle sensor 28, the steering torque sensor 29, the accelerator sensor 30, and the brake sensor 31 (step S1).

Next, the controller 10 detects the driver's line of sight on the basis of the signal received from the in-vehicle camera 32 (step S2).

Next, based on the travel environment information acquired in step S1, the controller 10 acquires the object (the cautionary object), to which the driver should pay attention, in front of the vehicle 1 in the advancing direction (step S3). Examples of the cautionary object include another vehicle, the obstacle, the pedestrian, a traffic light, and a road sign.

Next, based on the driver's line of sight detected in step S2, the controller 10 acquires the distribution of the driver's gazing points for the latest predetermined time (for example, 30 seconds) (step S4). For example, when it is detected that the driver's line of sight has stagnated for a predetermined time (for example, 0.3 second) on the basis of the driver's line of sight detected in step S2, the controller 10 identifies a position of the gazing point by expressing a direction of the line of sight, that is, a direction from the driver's head position toward the gazing point by a combination of an azimuth and an elevation angle with the advancing direction of the vehicle being a reference. Then, the positions of the identified gazing points are accumulated in the memory 10b. The position of the gazing point is accumulated repeatedly during the execution of the driver state estimation processing. Then, in step S4, the controller 10 reads the positions of the gazing points for the latest predetermined time, which are accumulated in the memory 10b, so as to acquire the distribution of the gazing points.

Next, the controller 10 determines whether the number of the cautionary objects acquired in step S3 is equal to or greater than a predetermined threshold N1 (step S5). N1 is set in advance and stored in the memory 10b. The travel environment where the number of the cautionary objects is less than N1 corresponds to a travel environment where the number of the cautionary objects is relatively small, such as the expressway.

As a result, if the number of the cautionary objects is not equal to or greater than N1 (that is, less than N1) (step S5: NO), the controller 10 sets a central range A1 having a size that corresponds to the travel environment where the number of the cautionary objects is relatively small, and calculates the ratio of the gazing points included in the central range A1 (the center checking ratio p) (step S6). The central range A1 is set as a circular range that is centered on an average direction of the distribution of the line-of-sight directions for the latest predetermined time (for example, 30 seconds). In addition, the size of the central range A1 (the value acquired by representing the radius of the central range by the viewing angle with the head position of the driver being the reference) is set to 3 deg on the basis of the result of the above-described driving experiment, for example.

On the other hand, if the number of the cautionary objects is equal to or greater than N1 (step S5: YES), the controller 10 determines whether the number of the cautionary objects acquired in step S3 is equal to or greater than a predetermined threshold N2 (step S7). N2 is a value larger than N1, is preset in advance, and is stored in the memory 10b. The travel environment at the time when the number of the cautionary objects is equal to or greater than N1 and less than N2 corresponds to the travel environment where the number of the cautionary objects is average, such as the ordinary road without the intersection. The travel environment at the time when the number of the cautionary objects is equal to or greater than N2 corresponds to the travel environment where the number of the cautionary objects is relatively large, such as the ordinary road with the intersection.

As a result, if the number of the cautionary objects is not equal to or greater than the predetermined threshold N2 (that is, is equal to or greater than N1 and less than N2) (step S7: NO), the controller 10 sets a central range A2 having a size that corresponds to the travel environment where the number of the cautionary objects is average, and calculates the ratio of the gazing points included in the central range A2 (the center checking ratio p) (step S8). The central range A2 is set as a circular range that is centered on the average direction of the distribution of the line-of-sight directions for the latest predetermined time (for example, 30 seconds). In addition, the size of the central range A2 is set to 4 deg on the basis of the result of the above-described driving experiment, for example.

On the other hand, if the number of the cautionary objects is equal to or greater than N2 (step S7: YES), the controller 10 sets a central range A3 having a size that corresponds to the travel environment where the number of the cautionary objects is relatively large, and calculates the ratio of the gazing points included in the central range A3 (the center checking ratio p) (step S9). The central range A3 is set as a circular range that is centered on the average direction of the distribution of the line-of-sight directions for the latest predetermined time (for example, 30 seconds). The size of the central range A3 is set to 6 deg on the basis of the result of the above-described driving experiment, for example.

After the processing in steps S6, S8, or S9, the controller 10 determines whether the calculated center checking ratio p is equal to or greater than a threshold pₜₕ (step S10). The threshold pₜₕ is set in advance and stored in the memory 10b. The threshold pₜₕ is set to 0.5 on the basis of the result of the above-described driving experiment, for example.

As a result, if the center checking ratio p is equal to or greater than the threshold pₜₕ (step S10: YES), it is considered that the driver's line of sight is concentrated in the central range, and the line of sight is less likely to be moved out of the central range. Thus, the controller 10 estimates that the driver is in the abnormal state (step 11).

Next, the controller 10 transmits the control signal to the display 36 and the speaker 37, and causes the display 36 and the speaker 37 to output an alarm for notifying the driver that the driver is in the abnormal state (step S12). At this time, the display 36 and the speaker 37 may be made to output the image information and the audio information (line-of-sight guidance information) for guiding the driver's line of sight to the cautionary object that the driver has not visually recognized.

On the other hand, if the center checking ratio p is not equal to or greater than the threshold pₜₕ (step S10: YES), it is considered that the driver's line of sight is frequently moved not only within the central range but to the outside the central range. Thus, the controller 10 estimates that the driver's state is normal (step S13).

After step S12 or S13, the controller 10 terminates the driver state estimation processing.

### Modified Examples

In the above-described embodiment, it has been described that the central range is set as the circular range centered on the average direction of the distribution of the line-of-sight directions for the latest predetermined time (for example, 30 seconds). However, the central range may be a range centered on the advancing direction of the vehicle or may have a shape other than the circle.

### Operation/Effects

Next, operation and effects of the driver state estimation apparatus 100 in the present embodiment described above will be described.

The controller 10 estimates that the driver is in the abnormal state in the case where the ratio (center checking ratio p) of the gazing points that are included in the central range including the line-of-sight direction of the case where the driver directs his/her line of sight in the advancing direction of the vehicle 1 among all the gazing points included in the distribution of the driver's gazing points within the predetermined time is equal to or greater than the predetermined threshold pₜₕ. Thus, based on the center checking ratio p, it is possible to identify that the tendency of the driver's line of sight to concentrate on the vicinity of the advancing direction is increased due to some disorder, and it is thus possible to accurately estimate that the driver is in the abnormal state regardless of the travel environment.

In addition, since the controller 10 sets the size of the central range on the basis of the travel environment information, by setting the central range in the appropriate size according to the travel environment information, it is possible to further accurately estimate whether the driver's state is abnormal according to the travel environment.

Furthermore, when the number of the cautionary objects is equal to or greater than the predetermined threshold, the controller 10 sets the central range to be larger than that in the case where the number of the cautionary objects is less than the predetermined threshold. Accordingly, based on the characteristic that the tendency of the line of sight of the driver in the abnormal state to concentrate on the vicinity of the advancing direction of the vehicle 1 is increased as the number of the cautionary objects is relatively reduced, it is possible to set the central range in such a size that the difference from the driver in the normal state becomes apparent, and it is thus possible to further accurately estimate whether the driver's state is abnormal according to the travel environment.

Furthermore, since the controller 10 sets the circular range, which is centered on the average direction of the distribution of the line-of-sight directions within the predetermined time, as the central range, it is possible to set the central range serving as the reference for estimating the driver's state on the basis of the line-of-sight direction of the actual driver, and it is thus possible to further accurately estimate whether the driver's state is abnormal.

### REFERENCE SIGNS LIST

1: vehicle
10: controller
100: driver state estimation apparatus
21: outside camera
22: radar
23: navigation system
24: positioning system
25: vehicle speed sensor
26: acceleration sensor
27: yaw rate sensor
28: steering angle sensor
29: steering torque sensor
30: accelerator sensor
31: brake sensor
32: in-vehicle camera
36: display
37: speaker

1. A driver state estimation apparatus that estimates a state of a driver who drives a vehicle, the driver state estimation apparatus comprising:
a camera that detects a line of sight of the driver; and
processing circuitry configured to
estimate a state of the driver based on the line of sight of the driver,
set a predetermined visual range that includes a line-of-sight direction in a case where the driver directs their line of sight in an advancing direction of the vehicle,
acquire a distribution of gazing points of the driver within a predetermined time based on the line of sight of the driver, and
estimate that the driver is in an abnormal state in a case where a ratio of the gazing points included in the predetermined visual range among all the gazing points included in the acquired distribution of the gazing points is equal to or greater than a predetermined ratio.

2. The driver state estimation apparatus according to claim 1, wherein he processing circuitry is further configured to
acquire travel environment information of the vehicle, and
set a size of the predetermined visual range based on the travel environment information.

3. The driver state estimation apparatus according to claim 2, wherein the processing circuitry is further configured to
acquire a number of cautionary objects in vicinity of the vehicle based on the travel environment information; and
increase the predetermined visual range in a case that the number of the cautionary objects is equal to or greater than a predetermined threshold.

4. The driver state estimation apparatus according to claim 2, wherein the processing circuitry is further configured to
set, as the predetermined visual range, a circular range centered on an average direction of a distribution of the line-of-sight directions within a predetermined time based on the line of sight of the driver.

5. The driver state estimation apparatus according to claim 3, wherein the cautionary objects include at least one of another vehicle, an obstacle, a pedestrian, a traffic light, and a road sign.

6. The driver state estimation apparatus according to claim 1, wherein the predetermined time is approximately 30 seconds.

7. The driver state estimation apparatus according to claim 1, wherein the processing circuitry is further configured to
output an alarm in a case that the driver is estimated to be in the abnormal state.

8. The driver state estimation apparatus according to claim 3, wherein the processing circuitry is further configured to
in a case that the number of cautionary objects is less than the predetermined threshold, set the size of the predetermined visual range to a first size,
in a case that the number of cautionary objects is equal to or greater than the predetermined threshold but less than a second predetermined threshold, set the size of the predetermined visual range to a second size, and
in a case that the number of cautionary objects is equal to or greater than the second predetermined threshold, set the size of the predetermined visual range to a third size.

9. The driver state estimation apparatus according to claim 1, wherein the predetermined ratio is 0.5.

10. The driver state estimation apparatus according to claim 1, wherein the processing circuitry is further configured to
identify a gazing point when the line of sight of the driver has stagnated for approximately 0.3 seconds.

11. A method of estimating a state of a driver who drives a vehicle, the method comprising:
detecting, with a camera, a line of sight of the driver;
setting a predetermined visual range that includes a line-of-sight direction in a case where the driver directs their line of sight in an advancing direction of the vehicle;
acquiring a distribution of gazing points of the driver within a predetermined time on a basis of the line of sight of the driver; and
estimating that the driver is in an abnormal state in a case where a ratio of the gazing points included in the predetermined visual range all the gazing points included in the acquired distribution of the gazing points is equal to or greater than a predetermined ratio.

12. The method according to claim 11, further comprising:
acquiring travel environment information of the vehicle; and
setting a size of the predetermined visual range based on the travel environment information.

13. The method according to claim 12, further comprising:
acquiring a number of cautionary objects in a vicinity of the vehicle on a basis of the travel environment information; and
increasing the predetermined visual range in a case where the number of the cautionary objects is equal to or greater than a predetermined threshold.

14. The method according to claim 11, further comprising:
setting, as the predetermined visual range, a circular range centered on an average direction of a distribution of line-of-sight directions within the predetermined time.

15. The method according to claim 11, wherein the cautionary objects include at least one of another vehicle, an obstacle, a pedestrian, a traffic light, and a road sign.

16. The method according to claim 11, further comprising:
outputting an alarm when the driver is estimated to be in the abnormal state.

17. A non-transitory computer-readable medium storing instructions that, when executed by processing circuitry, cause the processing circuitry to perform a method of estimating a state of a driver who drives a vehicle, the method comprising:
receiving, from a camera, data indicating a line of sight of the driver;
setting a predetermined visual range that includes a line-of-sight direction in a case where the driver directs their line of sight in an advancing direction of the vehicle;
acquiring a distribution of gazing points of the driver within a predetermined time on a basis of the line of sight of the driver; and
estimating that the driver is in an abnormal state in a case where a ratio of the gazing points included in the predetermined visual range among all the gazing points included in the acquired distribution of the gazing points is equal to or greater than a predetermined ratio.

18. The non-transitory computer-readable medium according to claim 17, further comprising:
acquiring travel environment information of the vehicle; and
setting a size of the predetermined visual range on a basis of the travel environment information.

19. The non-transitory computer-readable medium according to claim 15, further comprising:
acquiring a number of cautionary objects in a vicinity of the vehicle on a basis of the travel environment information; and
setting the predetermined visual range to be larger than that in a case where the number of the cautionary objects is less than a predetermined threshold when the number of the cautionary objects is equal to or greater than the predetermined threshold.

20. The non-transitory computer-readable medium according to claim 14, further comprising:
setting, as the predetermined visual range, a circular range centered on an average direction of a distribution of line-of-sight directions within the predetermined time.
